(19) United States
(12) Patent Application Publication
(10) Pub. No.: US 2005/0096918 A1
(43) Pub. Date: May 5, 2005

(54) Reduction of memory requirements by overlaying buffers

(76) Inventors: Arun Rao, Bangalore (IN); Sunoj Koshy, Bangalore (IN)

Correspondence Address: MCANDREWS HELD & MALLOY, LTD, 500 WEST MADISON STREET, SUITE 3400, CHICAGO, IL, 60661, US

(21) Appl. No.: 10/725,771

(22) Filed: Dec. 2, 2003

Related U.S. Application Data
(60) Provisional application No. 60/516,531, filed on Oct. 31, 2003.

(51) Int. Cl. G10L 19/00

(52) U.S. Cl. 704/500

(57) ABSTRACT

Presented herein is a method and system for reducing the total memory required by an audio decoding device by providing audio decoder buffer optimization, memory overwriting capability during audio decoding, and ordered processing of audio decoder program operations. Memory may be reduced by applying the buffer overlaying method to reduce the amount of memory to perform audio decoding to a minimum amount of memory. Audio decoding devices implementing the memory reducing method may be provided with a minimum amount of memory, reducing the cost of the audio decoding devices while efficiently decoding audio signals.

### CROSS-REFERENCE TO RELATED APPLICATIONS/INCORPORATION BY REFERENCE

The present application claims the benefit of U.S. Provisional Application No. 60/516,531 entitled REDUCTION OF MEMORY REQUIREMENTS BY OVERLAYING BUFFERS filed on Oct. 31, 2003, the complete subject matter of which is hereby incorporated herein by reference in its entirety.

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

Pursuant to the MPEG-2 Advanced Audio Coding (MPEG-2 AAC) standard, audio signals are sampled at 48K samples/second. The samples are grouped into consecutive frames of 1024 samples. Windowing is applied on a block of audio samples. The block length “N” could be either 2048 or 256 samples. However, each window has a 50% overlap with the previous window. Accordingly, the first N/2 samples of a window are the same as the last N/2 samples of the previous window. A window function may be applied to each window, resulting in sets of 2048 or 256 windowed samples. The modified discrete cosine transformation may be applied to each set of windowed samples, resulting in N/2 frequency coefficients. The frequency coefficients may then be quantized and coded for transmission.

A first step in decoding an AAC bitstream is to establish frame synchronization. Once the frame synchronization is found, the AAC can be decoded to generate audio time domain samples. The decoding process includes Huffman decoding, scale factor decoding, and decoding of side information used in tools, such as, Mid/Side decoding (M/S), intensity stereo, TNS, and filter bank. The decoded spectral samples are copied to at least one output buffer in sampled fashion. After Huffman decoding, each coefficient may be inverse quantized by a 4/3 power nonlinearity, and then scaled by the quantizer step size. The Inverse MDCT (IMDCT) transforms the spectral coefficients into time domain. After the IMDCT transform, the output samples are windowed, overlapped, and added for generating the final pulse code modulate (PCM) samples.

The foregoing decoding functions use varying amounts of memory, and varying amounts of memory may be allocated for each function. However, as each additional function uses additional memory, costs increase. Further, on an integrated circuit, additional memory occupies additional expensive silicon real estate.

Further limitations and disadvantages of conventional and traditional systems will become apparent to one of skill in the art through comparison of such systems with the invention set forth in the remainder of the present application and with reference to the drawings.

### SUMMARY OF THE INVENTION

Aspects of the present invention may be found in a method of reducing memory required to decode an audio signal in an audio decoding system. The method may comprise performing a first audio decoding function, writing data corresponding to the first audio decoding function to a memory, performing a second audio decoding function and writing data corresponding to the second audio decoding function to at least a portion of the memory. The data corresponding to the first audio function may be at least partially overwritten by the data corresponding to the second audio decoding function.

In another embodiment of the present invention, the audio decoding functions may be adapted for processing all groups together.

In another embodiment of the present invention, the method may further comprise the audio decoding functions that may be performed in an order based upon memory allocation.

In another embodiment of the present invention, a minimum amount of memory may be allocated to perform all of the audio decoding functions of a particular group.

In another embodiment of the present invention, a minimum amount of memory required to perform all audio decoding functions in a single memory device may be allocated.

In another embodiment of the present invention, each of a plurality of memory devices may be allocated to storing data corresponding to at least one audio decoding function.

In another embodiment of the present invention, each of a plurality of memory devices may be allocated to storing data corresponding to a group of audio decoding functions.

In another embodiment of the present invention, at least one audio decoding function may be optimized to reduce memory used to process the function.

In another embodiment of the present invention, the method may further comprise performing a plurality of audio decoding functions in a single memory device, wherein memory sufficient to perform an audio decoding function using a maximum amount of memory may be allocated, and each audio decoding function may be performed using less memory in the single memory device.

In another embodiment of the present invention, the method may further comprise performing a third audio decoding function using another memory, and writing data corresponding to the second audio decoding function to at least a portion of the other memory. The data corresponding to the third audio function may be at least partially overwritten by the data corresponding to the second audio decoding function.

In another embodiment of the present invention, the method may further comprise performing a plurality of audio decoding functions grouped into a plurality of groupings in a plurality of memory devices, allocating memory sufficient to perform an audio decoding function using a maximum amount of memory within each grouping, and performing all audio decoding functions in a grouping within the memory allocated to perform the function using the maximum amount of memory.

Another aspect of the present invention may be found in an integrated circuit for decoding a audio data, the integrated circuit may comprise a controller, a memory connected to the controller and an instruction memory connected to the controller. The instruction memory may comprise a plurality of instructions, wherein execution of the plurality of instructions by the controller may cause performing a first audio decoding function, writing data corresponding to the first audio decoding function to the memory, performing a second audio decoding function, and writing data corresponding to the second audio decoding function to at least a portion of the memory, whereby the data corresponding to the first audio function may be at least partially overwritten by the data corresponding to the second audio function.

In another embodiment of the present invention, the audio decoding functions for processing may be grouped together.

In another embodiment of the present invention, execution of the plurality of instructions by the controller may further causes performing the audio decoding functions in an order based upon memory allocation.

In another embodiment of the present invention, the integrated circuit may further comprise a plurality of memory devices connected to the controller, wherein each of the plurality of memory devices may be allocated to storing data corresponding to at least one audio decoding function.

In another embodiment of the present invention, each of the plurality of memory devices may be allocated to storing data corresponding to a group of audio decoding functions.

In another embodiment of the present invention, at least one audio decoding function may be optimized to reduce memory used to store data corresponding to the audio decoding function.

Another aspect of the present invention may be found in a system for decoding audio signals with a minimum amount of memory, the system may comprise a controller for performing a plurality of audio functions, and at least one memory device for storing data corresponding to an initially performed audio decoding function and storing data corresponding to a later performed audio decoding function, wherein the data corresponding to the initially performed audio decoding function may be at least partially overwritten by the data corresponding to the later performed audio decoding function.

Another embodiment of the present invention may further comprise an instruction memory for storing a plurality of instructions, wherein execution of the plurality of instructions by the controller may cause performing the plurality of audio functions.

These and other advantages and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 illustrates a block diagram describing the encoding of an audio signal in accordance with an embodiment of the present invention;

FIG. 2 illustrates a block diagram of an AAC bitstream decoder in accordance with an embodiment of the present invention;

FIG. 3 illustrates a block diagram describing an exemplary AAC decoder and overlaying memory arrangement in accordance with an embodiment of the present invention; and

FIG. 4 illustrates a flow diagram for reducing memory required by an audio decoding device to a minimum amount necessary to perform an audio decoding function in accordance with an embodiment of the present invention.

### DETAILED DESCRIPTION OF THE INVENTION

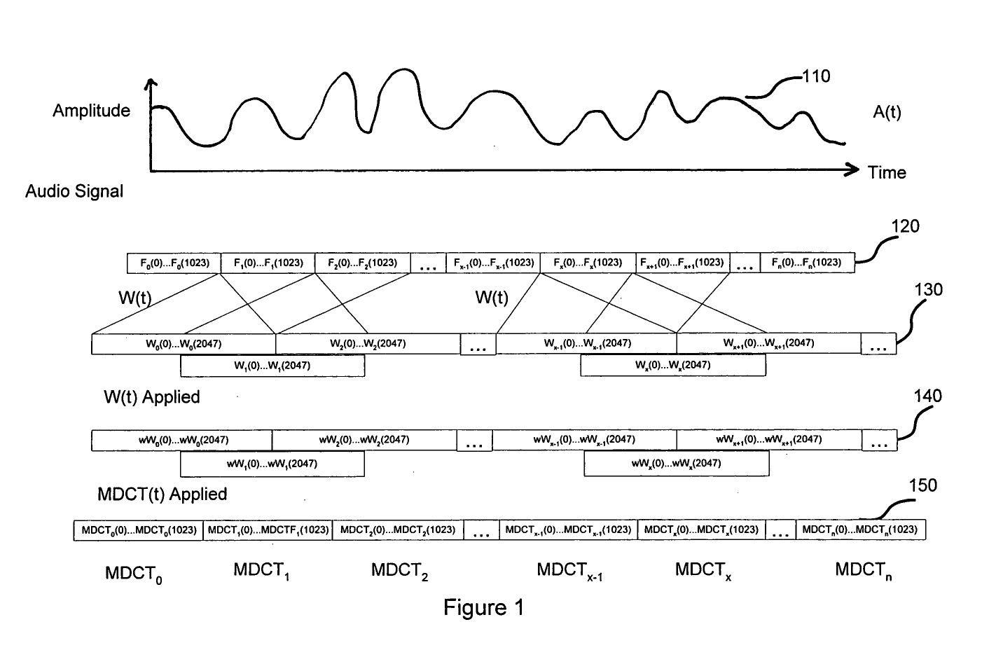

Referring now to FIG. 1, there is illustrated a block diagram 100 describing encoding of an exemplary audio signal A(t) 110. Pursuant to the MPEG-2 Advanced Audio Coding (MPEG-2 AAC) standard, audio signal 110 may be sampled at 48K samples/second. The samples may be grouped into frames F₀ . . . Fₙ of 1024 samples 120, e.g., Fₓ(0) . . . Fₓ(1023). Windowing may be applied on a block of audio samples 130. The block length “N” could be either 2048 or 256 samples.

Each window Wₓ may have a 50% overlap with the previous window Wₓ₋₁. Accordingly, the first N/2 samples of a window Wₓ may be the same as the last N/2 samples of the previous window Wₓ₋₁. A window function w(t) may be applied to each window W₀ . . . Wₙ, resulting in sets wW₀ . . . wWₙ of 2048 windowed samples 140, e.g., wWₓ(0) . . . wWₓ(2047). For example, for a short block having 256 samples, windowing may be applied for each of the 256 samples, resulting in 2048 samples, after windowing has been applied on all of the 8 short blocks.

A modified discrete cosine transformation (MDCT) may be applied to each set wW₀ . . . wWₙ of windowed samples wWₓ(0) . . . wWₓ(2047), resulting in sets MDCT₀ . . . MDCTₙ of 1024 frequency coefficients 150, e.g., MDCTₓ(0) . . . MDCTₓ(1023).

The sets of frequency coefficients MDCT₀ . . . MDCTₙ are then quantized and coded for transmission, forming what is known as an audio elementary stream (AES). The AES can be multiplexed with other AES's. The multiplexed signal, known as the Audio Transport Stream (Audio TS) can then be stored and/or transported for playback on a playback device. The playback device can either be locally or remotely located.

Where the playback device is remotely located, the multiplexed stream may be transported over a communication medium, such as the Internet. During playback, the multiplexed transport stream may be de-multiplexed, resulting in individual Audio Transport Streams. The Audio Transport Streams may be stripped of their additional headers. The constituent AESs may be decoded, resulting in an audio signal.

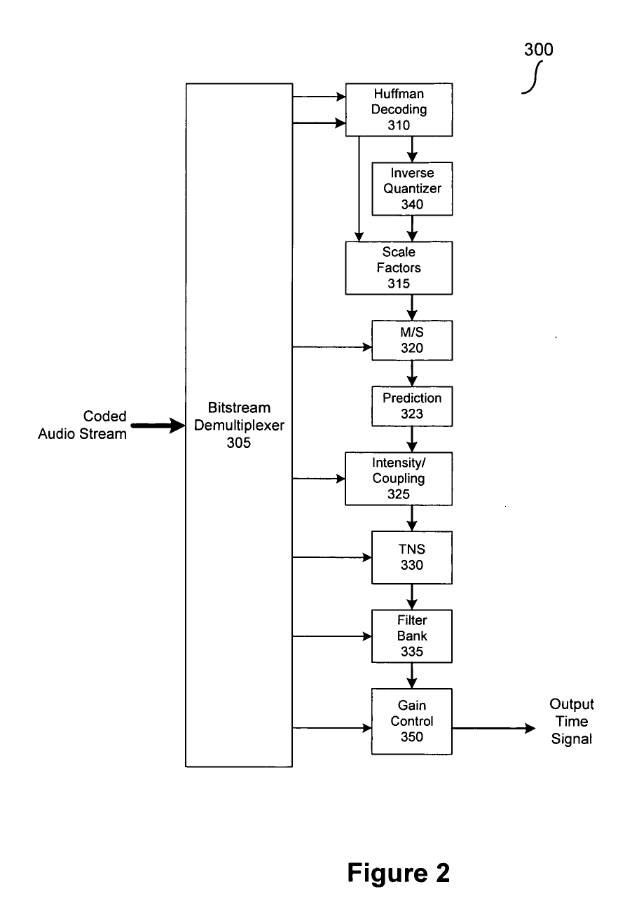

Referring now to FIG. 2, there is illustrated a block diagram 300 describing an exemplary AAC decoder in accordance with an embodiment of the present invention. Once frame synchronization is found, the AAC bitstream may be de-multiplexed by a bitstream de-multiplexer 305.

This provides information required for Huffman decoding 310, scale factor decoding 315, and decoding of side information used in tools such as Mid/Side (M/S) 320, prediction decoding 323, intensity stereo 325, TNS 330, and filter bank 335.

Sets of frequency coefficients MDCT₀ . . . MDCTₙ may be decoded and copied to an output buffer in a sampled fashion. After Huffman decoding 310, an inverse quantizer 340 may inverse quantize each sample of audio translatable frequency coefficient by a 4/3 power nonlinearity. The scale factors 315 may then be used to scale sets of frequency coefficients MDCT₀ . . . MDCTₙ by the quantizer step size.

Additionally, tools including M/S decoding 320, intensity stereo 325, TNS 330, and filter bank 335 may apply further functions to the sets of frequency coefficients MDCT₀ . . . MDCTₙ. The gain control 350 may transform the frequency coefficients MDCT₀ . . . MDCTₙ into a time domain signal A(t). The filter bank 335 and/or the Gain control 350 may transform the frequency coefficients by application of an Inverse MDCT (IMDCT), the inverse window function, window overlap, and window adding.

The output of the decoding functions, described above are time domain samples. These time domain samples may then be fed to Digital to Analog converters (DACs), the output of which is a continues time audio signal A(t).

The decoding functions, set forth above, use memory in order to buffer the input data, output data, and execution of intermediate program operations.

Tables 1-8 below list various buffers which may be accessed and used by various decoding functions, individually, and/or in optimized and/or un-optimized groupings. The listed buffers in the tables may comprise a total of 32,346 16-bit words of memory. However, due to cost and space considerations, it may be desirable to reduce the amount of memory required for the buffers.

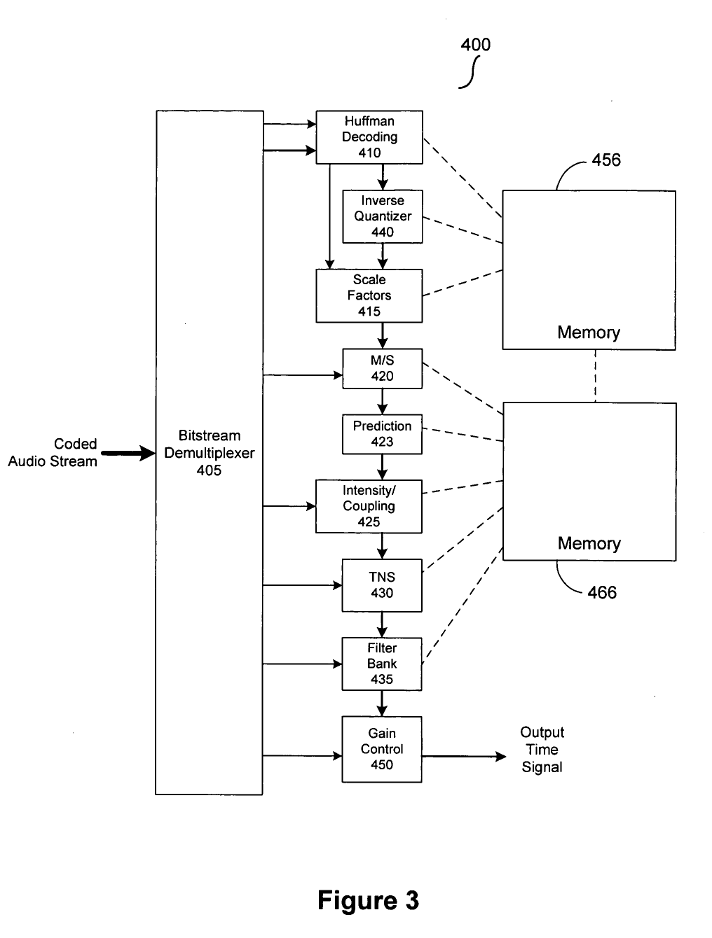

Referring now to FIG. 3, there is illustrated a block diagram 400 describing an exemplary AAC decoder with an overlaying buffer memory arrangement comprising at least two memory units 456 and 466, according to an embodiment of the present invention. Audio decoding operations, such as the following, may be performed in buffers, for example, Huffman decoding 410, inverse quantizing 440, scale factor decoding 415, Mid/Side decoding (M/S) 420, prediction decoding 423, intensity stereo/coupling 425, TNS 430, and filter bank 435, for example.

Reducing memory requirements for audio decoding may be accomplished by determining the various buffers that are used by the decoding functions, grouping the buffers together, ensuring that the buffers in the group are used by functions which have minimum or no dependency at all with each other and determining the minimum amount of memory required to perform these functions individually or as a group.

In Table 1 below, several exemplary decoder buffers and related decoder buffer grouping are displayed. The audio decoding buffers may be grouped together in groups called Unions, for example Union 1 in Table 1, i.e., performing sets of related audio decoding buffering operations. Each audio decoder buffer may comprise a predetermined amount of memory.

For example, the M/S 420, prediction decoding 423, Intensity coupling 425, TNS 430, and filter bank 435 may use the coef buffer comprising 6144 words for various decoding operations. The Bitstream De-multiplexer 405 may use the comp data buffer comprising 2688 words. The Huffman decoder 410 may use the Huffman table buffer comprising 2050 words.

Therefore, a total of 10,882 16-bit words of memory may be provided for use by the three buffers, coef, comp data and Huffman table, and the grouping entitled Union 1. However, because the coef buffer may be used at a time that is non-concurrent with usage of the comp data buffer and the Huffman table buffer, the coef buffer may overlay the comp data buffer and the Huffman table buffer.

In an embodiment of the present invention, the memory may be reduced to 6144 16-bit words of memory. The coef buffer may comprise 6144 words, the comp data buffer may comprise 2688 words, and the Huffman table buffer may comprise 2050 words. The comp data buffer and the Huffman table buffer may each overlay the coef buffer.

Additionally, by virtue of the Optimization Process, the coef buffer may use 4096 words instead of 6144 words. The foregoing Optimization Process is described in detail in “REDUCTION OF MEMORY REQUIREMENTS BY DE-INTERLEAVING AUDIO SAMPLES WITH TWO BUFFERS”, U.S. application patent Ser. No. ______ (to be assigned), identified by attorney docket number 15145US02, filed Nov. 19, 2003, by Rao et al.

In an embodiment of the present invention, only 4738 words of memory may needed for the three buffers. The coef buffer comprising 4096 words may overlay the 4738 words for the comp data buffer (2688 words) and the Huffman table buffer (2050 words).

TABLE 1

| | Name | Size in 16 bit | | Minimum |
|---|---|---|---|---|
| | Union 1 | words | Optimized size | Memory |
| D | coef | 6144 | 4096 | |
| P | comp data | 2688 | 2688 | |
| P | Huffman table | 2050 | 2050 | |

| | | | |
|---|---|---|---|
| Total Words of Memory | 10,882 | 8834 | 4738 |

Table 1 is a table displaying numerous exemplary audio decoding buffers and an exemplary grouping of audio decoding buffers.

By providing Optimization, and buffer overlaying, 4738 16-bit words of memory may be used. Applying a memory overlaying method, as disclosed in the present invention, may reduce the amount of memory necessary to perform a subset of related audio decoding operations from, for example, 10,882 words to 4738 words of memory, a decrease of at least 56%.

In Table 2 below, several exemplary decoder buffers and related decoder buffer grouping are displayed. The audio decoding buffers may be grouped together in groups called Unions, for example Union 2 in Table 2, i.e., performing sets of related audio decoding buffering operations. Each audio decoder buffer may comprise a predetermined amount of memory.

In Table 2, decoder buffer Iqt table may comprise 2050 16-bit words of memory, the coupling flags buffer may comprise 1596 words, and the kbd long buffer may comprise 2048 words. The kbd short buffer may comprise 256 words, sin long buffer may comprise 2048 words, and sin short buffer may comprise 256 words. The buffer Dep coupling spectrum may comprise 2048 words. The buffers are listed in Table 2 below.

TABLE 2

| | Name | Size in 16 bit | | Minimum |
|---|---|---|---|---|
| | Union 2 | words | Optimized size | Memory |
| D | Iqt table | 2050 | 2050 | |
| P | coupling flags | 1596 | 1596 | |
| D | kbd long | 2048 | 2048 | |
| D | kbd short | 256 | 256 | |
| D | sin long | 2048 | 2048 | |
| D | sin short | 256 | 256 | |
| D | Dep coupling spectrum | 2048 | 2048 | |

| | | | |
|---|---|---|---|
| Total Words of Memory | 10,302 | 10,302 | 2050 |

Table 2 is a table displaying numerous exemplary audio decoding buffers and an exemplary grouping of audio decoding buffers.

For example in Table 2, the Inverse Quantizer function may use the Iqt table buffer comprising 2050 words. The Bitstream De-Multiplexer function may use the coupling flags buffer comprising 1596 words. The filter bank function may use the kbd long buffer comprising 2048 words, kbd short buffer comprising 256 words, sin long buffer comprising 2048 words, and the sin short buffer comprising 256 words, but only one buffer at any time. The Intensity Coupling Block function may use the Dep Coupling Spectrum buffer comprising 2048 words.

The seven buffers listed above in Table 2, Iqt table, coupling flags, kbd long, kbd short, sin long, sin short and Dep coupling spectrum, in an un-optimized state, may comprise 10,302 16-bit words of memory.

However, by providing Optimization, and buffer overlaying, only 2050 words of memory may be used. A memory having 2050 16-bit words may be sufficient because none of the decoding buffers in Table 2 comprise more than 2050 words of memory.

Therefore, applying a memory overlaying method may reduce the amount of memory from, for example, from 10,302 words to 2050 words of memory space, a decrease of at least 80%.

In Table 3 below, several exemplary decoder buffers and related decoder buffer grouping are displayed. The audio decoding buffers may be grouped together in groups called Unions, for example Union 3 in Table 3, i.e., performing sets of related audio decoding buffering operations. Each audio decoder buffer may comprise a predetermined amount of memory.

In Table 3, the decoder buffer sin short may comprise 256 16-bit words of memory, buffer kbd short may comprise 256 words, buffer mcinfo may comprise 700 words, and buffer single instance of coupling flag may comprise 228 words. The buffers are listed in Table 3 below.

TABLE 3

| | Name | Size in 16 | Optimized | Minimum |
|---|---|---|---|---|
| | Union 3 | bit words | size | Memory |
| D | sin short | 256 | 256 | |
| D | kbd short | 256 | 256 | |
| P | mcinfo | 700 | 700 | |
| D | single instance of coupling Flag | 228 | 228 | |

| | | | |
|---|---|---|---|
| Total Words of Memory | 1440 | 1440 | 700 |

Table 3 is a table displaying numerous exemplary audio decoding buffers and an exemplary grouping of audio decoding buffers.

For example in Table 3, the filter bank function may use the sin short buffer comprising 256 words and the kbd short buffer also comprising 256 words, but only one buffer at any time. The Bitstream De-Multiplexer function may use the mcinfo buffer comprising 700 words. The Intensity Coupling flag function may use the single incidence of coupling Flag buffer comprising 228 words.

The four buffers in Table 3 above, sin short, kbd short, mcinfo, and single instance of coupling flag, in an un-optimized state may comprise 1440 16-bit words of memory. However, by providing optimization, and buffer overlaying, only 700 words of memory may be used. A memory having a size of 700 16-bit words may be sufficient because none of the audio decoding buffers in Table 3 comprise more than 700 words of memory.

Therefore, applying a memory overlaying method may reduce the amount of memory from, for example, 1440 words to 700 words of memory space, a decrease of at least 52%.

In Table 4 below, several exemplary decoder buffers and related decoder buffer grouping are displayed. The audio decoding buffers may be grouped together in groups called Unions, for example Union 4 in Table 4, i.e., performing sets of related audio decoding buffering operations. Each audio decoder buffer may comprise a predetermined amount of memory.

In Table 4, the decoder buffer pretwiddle cos long may comprise 1024 16-bit words of memory, buffer pretwiddle cos short may comprise 128 words, buffer huff_L may comprise 1024 words, and buffer delaybuff may comprise 1024 words. The buffers are listed in Table 4 below.

TABLE 4

| | Name | Size in 16 bit | | Minimum |
|---|---|---|---|---|
| | Union 4 | words | Optimized size | Memory |
| D | pretwiddle cos long | 1024 | 1024 | |
| D | pretwiddle cos short | 128 | 128 | |
| DP | huff_L | 1024 | 1024 | |
| D | delaybuff | 1024 | 1024 | |

| | | | |
|---|---|---|---|
| Total Words of Memory | 3200 | 3200 | 1024 |

Table 4 is a table displaying numerous exemplary audio decoding buffers and an exemplary grouping of audio decoding buffers.

For example in Table 4, the IMDCT part of the filter bank function may use the pretwiddle cos long buffer comprising 1024 words and the pretwiddle cos short buffer comprising 128 words, but only one buffer at any time. The Huffman Decoding function may use the huff_L buffer comprising 1024 words. The window overlap add part of the Filter bank function may use the delaybuff buffer comprising 1024 words.

The four buffers in Table 4 above, pretwiddle cos long, pretwiddle cos short, huff_L and delaybuff, in an un-optimized state may comprise 3200 16-bit words of memory. However, by providing optimization, and buffer overlaying, only 1024 words of memory may be used. A memory having a size of 1024 16-bit words may be sufficient because none of the audio decoding buffers in Table 4 comprise more than 1024 16-bit words of memory.

Therefore, applying a memory overlaying method may reduce the amount of memory from, for example, 3200 words to 1024 words of memory space, a decrease of at least 68%.

In Table 5 below, several exemplary decoder buffers and related decoder buffer grouping are displayed. The audio decoding buffers may be grouped together in groups called Unions, for example Union 5 in Table 5, i.e., performing sets of related audio decoding buffering operations. Each audio decoder buffer may comprise a predetermined amount of memory.

In Table 5, the decoder buffer pretwiddle sin long may comprise 1024 16-bit words of memory, buffer pretwiddle sin short may comprise 128 words, and buffer huff_R may comprise 1024 words. The buffers are listed in Table 5 below.

TABLE 5

| | Name | Size in 16 bit | | Minimum |
|---|---|---|---|---|
| | Union 5 | words | Optimized size | Memory |
| D | pretwiddle sin long | 1024 | 1024 | |
| D | pretwiddle sin short | 128 | 128 | |
| DP | huff_R | 1024 | 1024 | |

| | | | |
|---|---|---|---|
| Total Words of Memory | 2176 | 2176 | 1024 |

Table 5 is a table displaying numerous exemplary audio decoding buffers and an exemplary grouping of audio decoding buffers.

For example in Table 5, the IMDCT part of the filter bank function may use the pretwiddle sin long buffer comprising 1024 words and the pretwiddle sin short buffer comprising 128 words, but only one buffer at any time. The Huffman Decoding function may use the huff_R buffer comprising 1024 words.

The three buffers in Table 5 above, pretwiddle sin long, pretwiddle sin short, and huff_R, in an un-optimized state may comprise 2176 16-bit words of memory. However, by providing optimization, and buffer overlaying, only 1024 words of memory may be used. A memory having a size of 1024 16-bit words may be sufficient because none of the audio decoding buffers in Table 5 comprise more than 1024 16-bit words of memory.

Therefore, applying a buffer overlaying method may reduce the amount of memory from, for example, 2176 words to 1024 words of memory space, a decrease of at least 53%.

In Table 6 below, several exemplary decoder buffers and related decoder buffer grouping are displayed. The audio decoding buffers may be grouped together in groups called Unions, for example Union 6 in Table 6, i.e., performing sets of related audio decoding buffering operations. Each audio decoder buffer may comprise a predetermined amount of memory.

In Table 6, the decoder buffer tns frame info may comprise 1124 16-bit words of memory, buffer twiddle buf may comprise 1024 words, and buffer Ind coupling spectrum may comprise 2048 words. The buffers are listed in Table 6 below.

TABLE 6

| | Name | Size in 16 bit | | Minimum |
|---|---|---|---|---|
| | Union 6 | words | Optimized size | Memory |
| DP | tns frame info | 1124 | 1124 | |
| D | twiddle buf | 1024 | 1024 | |
| D | Ind coupling spectrum | 2048 | 2048 | |

| | | | |
|---|---|---|---|
| Total Words of Memory | 4196 | 4196 | 2048 |

Table 6 is a table displaying numerous exemplary audio decoding buffers and an exemplary grouping of audio decoding buffers.

For example in Table 6, the Bitstream De-Multiplexer function may use the tns frame info buffer comprising 1124 words. The filter bank function/IMDCT function may use the twiddle buf buffer comprising 1024 words. The Intensity Coupling Block function may use the Ind coupling spectrum comprising 2048 words.

The three buffers in Table 6 above, tns frame info, twiddle buf, and Ind coupling spectrum, in an un-optimized state may comprise 4196 16-bit words of memory. However, by providing optimization, and buffer overlaying, only 2048 words of memory may be used. A memory having a size of 2048 16-bit words may be sufficient because none of the audio decoding buffers in Table 6 comprise more than 2048 16-bit words of memory.

Therefore, applying a buffer overlaying method may reduce the amount of memory from, for example, 4196 words to 2048 words of memory space, a decrease of at least 51%.

The buffer overlaying method may also be applied to a single audio decoding buffer, for example, such as the buffer listed in Table 7 below. For example, the audio decoding buffer single instance of mcinfo may comprise 150 16-bit words of memory. The buffer is listed in Table 7 below.

TABLE 7

| | Name | | | |
|---|---|---|---|---|
| Single Audio | | Size in 16 bit | Optimized | Minimum |
| Decoding Function | | words | size | Memory |
| D | single instance of mcinfo | 150 | 150 | |

| | |
|---|---|
| Total Words of Memory | 150 |

Table 7 is a table displaying an exemplary audio decoding buffer.

For example in Table 7, the M/S function/Filter bank function may use the single instance of mcinfo buffer comprising 150 words.

In an embodiment of the present invention, some or all of the audio decoding buffers illustrated in Tables 1-7 may be simultaneously accessed and used during decoding an audio signal. The groupings of audio decoding buffers may be optimized and a minimum amount of memory may be used. All of the Unions (1-6 described above, i.e., groups of related buffers) or several of the Unions, may be grouped for overlaying within a single memory unit, however each Union may also comprise an individual designated memory unit, as economics and efficient processing necessitate.

In an embodiment of the present invention, the minimum memory for all of the exemplary AAC decoding buffers is disclosed in Table 8. Taking advantage of overlaying buffer usage method with a single memory unit, for example, comprising 4738 16-bit words of memory, the decoding buffer(s) may comprise a single memory of 4738 words.

TABLE 8

| | | Size in 16 bit | | Optimized | | Minimum |
|---|---|---|---|---|---|---|
| | Name | words | | size | | Memory |
| | Union 1 | | | | | |
| D | coef | 6144 | | 4096 | | |
| P | comp data | 2688 | | 2688 | | |
| P | Huffman table | 2050 | | 2050 | | 4738 |
| | Union 2 | | | | | |
| D | Iqt table | 2050 | | 2050 | | |
| P | coupling flags | 1596 | | 1596 | | |
| D | kbd long | 2048 | | 2048 | | |
| D | kbd short | 256 | | 256 | | |
| D | sin long | 2048 | | 2048 | | |
| D | sin short | 256 | | 256 | | |
| D | Dep coupling spectrum | 2048 | | 2048 | | 2050 |
| | Union 3 | | | | | |
| D | sin short | 256 | | 256 | | |
| D | kbd short | 256 | | 256 | | |
| P | mcinfo | 700 | | 700 | | |
| D | single instance of coupling | 228 | | 228 | | |
| | flag | | | | | 700 |
| | Union 4 | | | | | |
| D | pretwiddle cos long | 1024 | | 1024 | | |
| D | pretwiddle cos short | 128 | | 128 | | |
| DP | huff_L | 1024 | | 1024 | | |
| D | delaybuff | 1024 | | 1024 | | 1024 |
| | Union 5 | | | | | |
| D | pretwiddle sin long | 1024 | | 1024 | | |
| D | pretwiddle sin short | 128 | | 128 | | |
| DP | huff_R | 1024 | | 1024 | | 1024 |
| | Union 6 | | | | | |
| DP | tns frame info | 1124 | | 1124 | | |
| D | twiddle buf | 1024 | | 1024 | | |
| D | Ind coupling spectrum | 2048 | | 2048 | | 2048 |
| | Single Audio Decoding Function | | | | | |
| D | single instance of mcinfo | 150 | | 150 | | 150 |
| | Total | 32,346 | Total | 30,298 | Minimum | 11,734 |
| | Un-Optimized | | Optimized | | Memory | |
| Table 8 is a table displaying numerous exemplary audio decoding buffers and several exemplary groupings of audio decoding buffers. Minimum Memory to Buffer Exemplary Audio Decoding may comprise 4738 16-bit words of memory, wherein the buffer may comprise | | | | | | |
| # a single memory of 4738 words applying the overlaying buffer method. Minimum Memory to Buffer Exemplary Audio Decoding may comprise 11734 16-bit words of memory, wherein the buffer may comprise a plurality of individual memory units without overlap. | | | | | | |

In an embodiment of the present invention, the exemplary audio decoding buffers disclosed in Table 8 may comprise 11,734 16-bit words of memory in a single memory unit or in a plurality of individual memory units with or without overlap. The memory units may be of a characteristic size for providing a specific audio decoding function or a specific group of related audio decoding functions. The examples provided herein are merely exemplary, that is, combinations of overlaying memory units and individualized memory units may also be provided for audio decoding function or a group of related audio decoding functions are also contemplated herein.

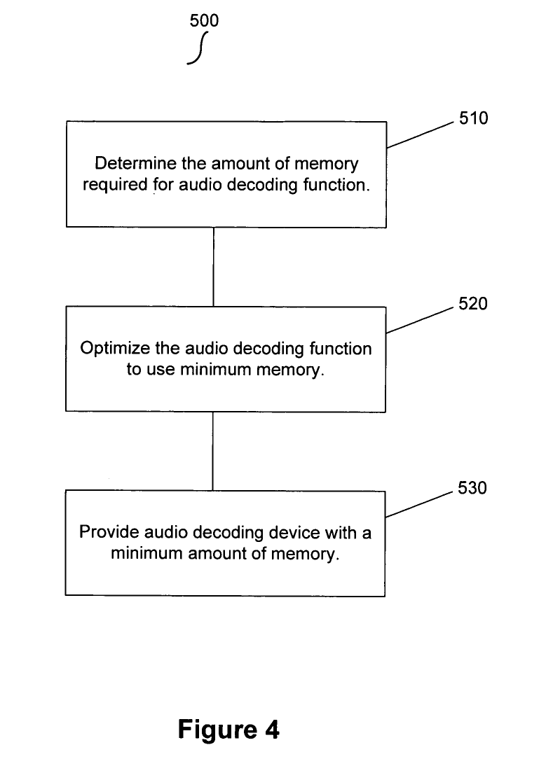

Referring now to FIG. 4, there is illustrated a flow diagram 500 for reducing the total memory required by an audio decoding device by performing audio decoder buffer optimizations through buffer overlaying. The memory required to perform an audio decoding function may be reduced to a minimum amount by applying the memory overlaying method.

In FIG. 4, a method of reducing memory in an audio decoding system is disclosed. The method may be accomplished by determining an amount of memory for an audio decoding function 510 by monitoring memory usage and optimizing the audio decoding function(s) to use a minimum amount of memory.

The method may also be carried out by optimizing an audio decoding function 520 by monitoring memory usage, analyzing memory allocation, determining data which may be overwritten, and calculating a minimum amount of memory required to perform the audio decoding function.

The method may also be accomplished by providing the audio decoding system with a minimum amount or memory 530.

The method may also be applicable to audio decoding involving a plurality of related or unrelated audio decoding program operations. A method of reducing memory required to perform a plurality of audio decoding program operations in an audio decoding system may be carried out by determining an amount of memory required to perform the operation, optimizing the amount of memory required to a minimum buffer size, associating these buffers into groups, determining an order of processing of audio decoding program operations within each group, determining a minimum amount of memory required to perform program operations within each group, and providing the audio decoding system with the minimum amount of memory to perform the audio decoding program operations within at least one group.

Determining the minimum amount of memory to perform audio decoding program operations within a group may be carried out by determining the audio decoding buffer within the group which comprises the most memory, determining whether any audio decoding buffers are accessed simultaneous to any other audio decoding buffers; and if two or more audio decoding buffers are simultaneously accessed, summing the memory requirements of each buffer to create a memory sum, determining whether the memory sum is greater than the most memory or whether the most memory is greater than the memory sum. The audio decoding device may be provided with memory sufficient to buffer the decoding operation(s) having the largest memory requirement.

Determining an order of buffering of audio decoding operations within each group of buffers may also be accomplished by determining whether any audio decoding buffers within the group are simultaneously accessed and which audio decoding buffers may be overwritten.

Associating related or unrelated audio decoding buffers into groups may be carried out by determining which audio decoding buffers have similar properties and arranging audio buffers determined to be capable of complementary buffering into groups.

Determining an amount of memory for each of a plurality of audio decoding buffers may be accomplished by monitoring memory usage during the audio decoder program operation.

Optimizing each of the audio decoding buffers may be carried out by monitoring memory usage during the program operation, analyzing memory allocation, determining data which may be overwritten, and calculating the minimum amount of memory.

The method and system described herein may be implemented as a board level product, a single chip, an application specific integrated circuit (ASIC), or within varying levels of an audio decoding system integrated with other portions of a system, or as separate components. The degree of integration with the audio decoding system will primarily be determined by speed and cost considerations.

Because of the sophisticated nature of modern processors, it may be possible to utilize a commercially available processor, which may be implemented external to an ASIC implementation. Alternatively, if a processor is available as an ASIC core or logic block, then the commercially available processor may be implemented as part of an ASIC device, wherein certain operations may be implemented in firmware.

While the present invention has been described with reference to certain embodiments, it may be understood by those skilled in the art that various changes may be made and equivalents substituted without departing from the scope of the present invention. In addition, many modifications may be made to adapt a particular situation or material to the teachings of the invention without departing from its scope. Therefore, it is intended that the invention not be limited to the particular embodiments disclosed herein, but rather that the invention include all embodiments falling within the scope of the appended claims.

1. A method of reducing memory required to decode an audio signal in an audio decoding system, the method comprising:
performing a first audio decoding function;
writing data corresponding to the first audio decoding function to a memory;
performing a second audio decoding function;
writing data corresponding to the second audio decoding function to at least a portion of the memory, whereby the data corresponding to the first audio function is at least partially overwritten by the data corresponding to the second audio decoding function.

2. The method according to claim 1, wherein the audio decoding functions are adapted for processing all groups together.

3. The method according to claim 2, further comprising performing the audio decoding functions in an order based upon memory allocation.

4. The method according to claim 2, wherein a minimum amount of memory to perform the audio decoding functions in a particular group is allocated.

5. The method according to claim 1, wherein a minimum amount of memory to perform all audio decoding functions in a single memory device is allocated.

6. The method according to claim 1, wherein each of a plurality of memory devices are allocated to storing data corresponding to at least one audio decoding function.

7. The method according to claim 6, wherein each of a plurality of memory devices are allocated to storing data corresponding to a group of audio decoding functions.

8. The method according to claim 1, wherein at least one audio decoding function is optimized to reduce memory used to process the function.

9. The method according to claim 1, further comprising performing a plurality of audio decoding functions in a single memory device, wherein memory sufficient to perform an audio decoding function using a maximum amount of memory is allocated, and each audio decoding function is performed using less memory in the single memory device.

10. The method according to claim 1, further comprising:
performing a third audio decoding function to another memory; and
writing data corresponding to the second audio decoding function to at least a portion of the other memory, whereby the data corresponding to the third audio function is at least partially overwritten by the data corresponding to the second audio decoding function.

11. The method according to claim 1, further comprising:
performing a plurality of audio decoding functions grouped into a plurality of groupings in a plurality of memory devices;
allocating memory sufficient to perform an audio decoding function using a maximum amount of memory within each grouping; and
performing all audio decoding functions in a grouping within the memory allocated to perform the function using the maximum amount of memory.

12. An integrated circuit for decoding a audio data, the integrated circuit comprising:
a controller;
a memory connected to the controller;
an instruction memory connected to the controller, the instruction memory comprising a plurality of instructions, wherein execution of the plurality of instructions by the controller causes:
performing a first audio decoding function;
writing data corresponding to the first audio decoding function to the memory;
performing a second audio decoding function; and
writing data corresponding to the second audio decoding function to at least a portion of the memory, whereby the data corresponding to the first audio function is at least partially overwritten by the data corresponding to the second audio function.

13. The integrated circuit of claim 12, wherein the audio decoding functions to be processed are grouped together.

14. The integrated circuit of claim 13, wherein execution of the plurality of instructions by the controller causes performing of the audio decoding functions in an order based upon memory allocation.

15. The integrated circuit of claim 13, further comprising:
a plurality of memory devices connected to the controller, wherein each of the plurality of memory devices are allocated to storing data corresponding to at least one audio decoding function.

16. The integrated circuit of claim 15, wherein each of the plurality of memory devices are allocated to storing data corresponding to a group of audio decoding functions.

17. The integrated circuit of claim 12, wherein at least one audio decoding function is optimized to reduce memory used to store data corresponding to the at least one audio decoding function.

18. A system for decoding audio signals with a minimum amount of memory, the system comprising:
a controller for performing a plurality of audio functions; and
at least one memory device for storing data corresponding to an initially performed audio decoding function, and storing data corresponding to a later performed audio decoding function, wherein the data corresponding to the initially performed audio decoding function is at least partially overwritten by the data corresponding to the later performed audio decoding function.

19. The system of claim 18, further comprising an instruction memory for storing a plurality of instructions, wherein execution of the plurality of instructions by the controller causes performing the plurality of audio functions.
